(19) United States
(12) Patent Application Publication
(10) Pub. No.: US 2012/0026267 A1
(43) Pub. Date: Feb. 2, 2012

(54) OPTICAL SCANNING DEVICE AND IMAGE FORMING APPARATUS

(76) Inventors: Nobuhiro SHIRAI, Osaka (JP); Kenzo Ohkubo, Osaka (JP)

(21) Appl. No.: 13/195,061

(22) Filed: Aug. 1, 2011

(30) Foreign Application Priority Data
Aug. 2, 2010 (JP) 2010-173780

(51) Int. Cl. B41J 2/385; G02B 26/10; G02B 26/08

(52) U.S. Cl. 347/118; 359/197.1; 359/201.1

(57) ABSTRACT

In an optical scanning device, a beam outputted from a light source is deflected by an optical deflector, and an object to be scanned (for example, a photosensitive drum) is scanned by the deflected beam. The optical scanning device is provided with a light source that outputs a beam, an aperture provided with an opening that shapes the beam outputted from the light source, a reducing optical portion that reduces the beam shaped by the aperture, and a collimator, which is arranged within an interval from the light source to the reducing optical portion, and makes the beam parallel. The reducing optical portion outputs the incoming beam as a parallel beam. The aperture and the reducing optical portion are arranged within an interval from the light source to the optical deflector.

### CROSS-REFERENCE TO RELATED APPLICATIONS

This application claims priority under 35 U.S.C. §119(a) on Patent Application No. 2010-173780 filed in Japan on Aug. 2, 2010, the entire contents of which are herein by incorporated by reference.

### BACKGROUND OF THE INVENTION

1. Field of the Invention

The present invention relates to optical scanning devices, and relates to image forming apparatuses provided with an optical scanning device.

2. Description of the Related Art

Conventionally, optical scanning devices are used in image forming apparatuses to expose a photosensitive body. In these optical scanning devices, a beam that is outputted from a light source is converted to a parallel beam by a collimator, and then the beam is shaped by an aperture. The size of the opening of the aperture is determined by the focal point distance of the lens that converges the beam onto the photosensitive body and the beam diameter on the surface of the photosensitive body. Here, when the size of the opening of the aperture is made small, the beam is greatly blocked. Along with this, to maintain the light amount of the attenuated beam, sometimes a high output light source or other measure is used.

Furthermore, in regard to the optical scanning device, to correct the beam pitch displacement produced by installation displacement of the light source, techniques have been considered of enabling a cylindrical lens to move (for example, see JP 2009-210760A).

Furthermore, techniques have been considered in which control of the light amount is carried out by feeding back the light from the light source (for example, see JP 2006-91157A).

In conventional image forming apparatuses, there is a limit to increasing the output of the light source, and therefore there is a problem in that the light amount for exposure cannot be maintained.

Further still, for the technique disclosed in JP 2009-210760A, there is no description regarding how to maintain the light amount of an attenuated beam using a diaphragm (aperture), and the above-described problem cannot be addressed.

Furthermore, the optical scanning device described in JP 2006-91157A carries out control of the light amount by detecting the light amount of the beam after it has been shaped by the aperture. And the output of the light source is increased to maintain the light amount that has been attenuated by the aperture. With the optical scanning device described in JP 2006-91157A, it is unavoidable that the output of the light source is increased.

### SUMMARY OF THE INVENTION

The present invention has been devised to address the above-described issues, and it is an object thereof to provide an optical scanning device in which the attenuation of a light amount of a beam by an aperture can be reduced.

Furthermore, another object of the present invention is to provide an image forming apparatus in which a light amount required for forming an image is secured by providing an optical scanning device in which the attenuation of a light amount can be reduced.

An optical scanning device according to the present invention is an optical scanning device in which a beam outputted from a light source is deflected by an optical deflector, and an object to be scanned is scanned by the deflected beam, and is provided with a light source that outputs a beam, an aperture provided with an opening that shapes the beam, and a reducing optical portion that reduces the beam, wherein the aperture and the reducing optical portion are arranged within an interval from the light source to the optical deflector.

With this configuration, attenuation of the light amount of the beam can be reduced.

In one embodiment according to the present invention, the aperture shapes the beam outputted from the light source, and the reducing optical portion reduces the beam shaped by the aperture. That is, an optical scanning device according to one embodiment of the present invention is directed to an optical scanning device in which a beam outputted from a light source is deflected by an optical deflector, and an object to be scanned is scanned by the deflected beam, and that is provided with a light source that outputs a beam, an aperture provided with an opening that shapes the beam outputted from the light source, and a reducing optical portion that reduces the beam shaped by the aperture, wherein the aperture and the reducing optical portion are arranged within an interval from the light source to the optical deflector.

With this configuration, a beam diameter of an optimal size can be obtained by the reducing optical portion. That is, since there is no need to reduce the beam with the aperture, the size of the opening of the aperture can be enlarged to enable a reduction in the attenuation of the light amount of the beam.

In the optical scanning device according to the present invention, it is preferable that a size of the opening is determined according to a reduction scaling factor of the reducing optical portion.

With this configuration, the opening of the aperture can be set to a size for obtaining a beam diameter of an optimal size.

In another embodiment according to the present invention, the reducing optical portion reduces the beam outputted from the light source, and the aperture shapes the beam reduced by the reducing optical portion. That is, an optical scanning device according to one embodiment of the present invention is directed to an optical scanning device in which a beam outputted from a light source is deflected by an optical deflector, and an object to be scanned is scanned by the deflected beam, and that is provided with a light source that outputs a beam, a reducing optical portion that reduces the beam outputted from the light source, and an aperture provided with an opening that shapes the beam reduced by the reducing optical portion, wherein the reducing optical portion and the aperture are arranged within an interval from the light source to the optical deflector.

With this configuration, due to the reducing optical portion, the beam diameter can be reduced without the light amount of the beam being attenuated. Furthermore, since the beam diameter is reduced, an aperture having a small size can be applied, which is beneficial in making the apparatus more compact.

In the optical scanning device according to the present invention, it is preferable that the reducing optical portion is configured provided with a convex lens and a concave lens, and outputs the incoming beam as a parallel beam.

With this configuration, a simple configuration can be achieved for outputting the beam as a parallel beam, and greater space-saving is possible. Furthermore, by outputting a beam that has been made a parallel beam, the position of the focal point can be adjusted easily, and there is an increased level of freedom in design.

It is preferable that the concave lens is arranged between the convex lens and the optical deflector. Furthermore, it is preferable that the optical scanning device according to the present invention is further provided with a cylindrical lens that is arranged between the concave lens and the optical deflector.

It is preferable that the optical scanning device according to the present invention is provided with a collimator, which is arranged within an interval from the light source to the reducing optical portion, and makes the beam parallel.

With this configuration, a simple configuration can be achieved for outputting the beam as a parallel beam.

In the optical scanning device according to the present invention, it is preferable that a reduction scaling factor of the reducing optical portion is different for a first scanning direction in which a beam scans an object to be scanned and a second scanning direction that is orthogonal to the first scanning direction.

With this configuration, a suitable reduction scaling factor can be set in response to the shape of the cross section of the beam irradiated on the object to be scanned.

The reduction scaling factor of the reducing optical portion may be one times (same scale as) the reduction scaling factor of the first scanning direction. That is, the reducing optical portion may converge the beam only in the second scanning direction.

It is preferable that an image forming apparatus according to the present invention is configured to form an image based on light scanned by the optical scanning device.

With this configuration, it is possible provide an image forming apparatus in which a light amount required for forming an image is secured by providing an optical scanning device in which the attenuation of a light amount can be reduced.

### BRIEF DESCRIPTION OF THE DRAWINGS

FIG. 1 is a schematic configuration drawing showing an image forming apparatus according to embodiment 1 of the present invention.

FIG. 2 is a schematic perspective view showing a configuration of an optical scanning device according to embodiment 2 of the present invention.

FIG. 3 is an outline perspective view showing a configuration of a modified example of an optical scanning device according to embodiment 2 of the present invention.

FIG. 4A and FIG. 4B are diagrams for describing a relationship between the beam outputted from the aperture and the reducing optical portion. FIG. 4A is a schematic top view showing the beam in a case where the reducing optical portion is not provided, and FIG. 4B is a schematic top view showing the beam in a case where the reducing optical portion is provided.

FIG. 5A and FIG. 5B are diagrams for describing a relationship between the beam diameter and the depth of focus. FIG. 5A is a schematic top view showing a case where the beam diameter is large, and FIG. 5B is a schematic top view showing a case where the beam diameter is small.

FIG. 6 is an outline perspective view showing a configuration of an optical scanning device according to embodiment 3 of the present invention.

### DETAILED DESCRIPTION OF THE INVENTION

### Embodiment 1

Hereinafter, description is given with reference to the accompanying drawings regarding an image forming apparatus provided with an optical scanning device according to embodiment 1 of the present invention.

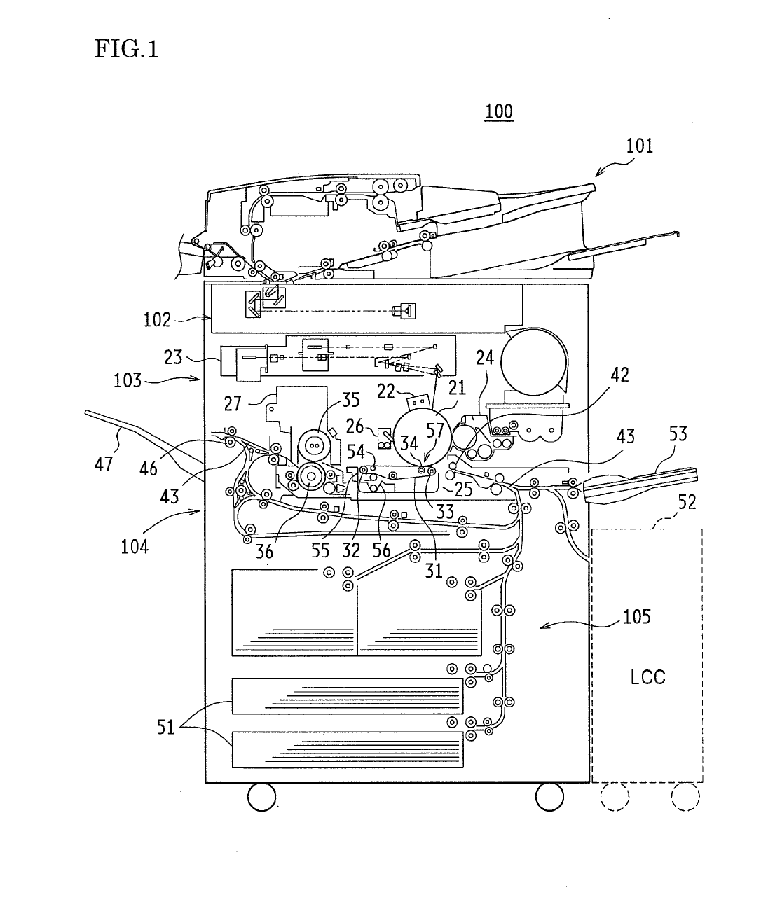

FIG. 1 is an outline configuration drawing showing an image forming apparatus according to embodiment 1 of the present invention.

An image forming apparatus 100 has a configuration provided with an original paper transport portion 101, an image reading portion 102, an image forming portion 103, a recording paper transport portion 104, and a paper feeding portion 105, and is a copier or the like for example. The image forming apparatus 100 forms monochrome images on paper in accordance with image data received externally or from the image reading portion 102.

The original paper transport portion 101 transports originals that have been set to the image reading portion 102.

The image reading portion 102 reads an image of the original and outputs this as image data to the image forming portion 103. It should be noted that various types of image processing may be executed on the image data by a control circuit such as a microcomputer prior to output.

The image forming portion 103 records on paper the original image that is indicated by the image data. The image forming portion 103 has a configuration that is provided with components such as a photosensitive drum 21, a charging unit 22, an optical scanning device 23, a development unit 24, a transfer unit 25, a cleaning unit 26, and a fixing device 27.

The surface of the photosensitive drum 21 is an organic photosensitive body. The surface of the photosensitive drum 21 is cleaned by the cleaning unit 26 then uniformly charged by the charging unit 22.

The charging unit 22 may be a charger type or may be a roller type or brush type that makes contact with the photosensitive drum 21.

The optical scanning device 23 is a laser scanning unit (LSU). The optical scanning device 23 emits laser beams corresponding to the inputted image data onto the photosensitive drum 21 to expose the uniformly charged surface of the photosensitive drum 21 such that an electrostatic latent image is formed on the surface of the photosensitive drum 21. That is, the image forming apparatus 100 is configured to form an image based on laser beams that are scanned by the optical scanning device 23. With this configuration, an image forming apparatus 100 can be provided that ensures the amount of light necessary for forming an image. It should be noted that configurations of the optical scanning device 23 are described in detail in embodiment 2 and embodiment 3.

The development unit 24 supplies toner to the surface of the photosensitive drum 21 to develop the electrostatic latent image and form a toner image (visible image) on the surface of the photosensitive drum 21.

The transfer unit 25 transfers the toner image on the surface of the photosensitive drum 21 to a recording paper that has been transported in by the recording paper transport portion 104. The transfer unit 25 is provided with such components as a transfer belt 31, a drive roller 32, an idler roller 33, and an elastic conductive roller 34, and the transfer belt 31 is caused to rotate while spanning the rollers 32 to 34 and other rollers in a tensioned state.

The transfer belt 31 has a predetermined volume resistivity value (for example, 1×10⁹ to 1×10¹³ Ω·cm). Furthermore, the elastic conductive roller 34, which is for applying a transfer electric field, is arranged near a region (an image transfer portion 57) where the photosensitive drum 21 and the transfer belt 31 contact each other.

The elastic conductive roller 34 applies pressure to the transfer belt 31 and the photosensitive drum 21 so that the transfer belt 31 presses against the photosensitive drum 21. Due to this, the image transfer portion 57 is not a line shape, but rather a surface shape having a predetermined width. Thus, the transfer efficiency onto the transported recording paper can be improved.

A transfer electric field of a polarity opposite to the charge of the toner image that has been formed on the surface of the photosensitive drum 21 is applied to the elastic conductive roller 34, and the toner image on the surface of the photosensitive drum 21 is transferred to the recording paper due to the opposite polarity transfer electric field. For example, in a case where the toner image takes on a charge of a negative polarity, the polarity of the transfer electric field applied to the elastic conductive roller 34 is a positive polarity.

Further still, a charge removal roller 54 is arranged on a downstream side in the paper transport direction from the image transfer portion 57. The charge removal roller 54 carries out a charge removal process on the paper that has been charged when passing through the image transfer portion 57. Due to the charge removal process, the transport of the recording paper to the fixing device 27 can be performed smoothly. In the present embodiment, the charge removal roller 54 is arranged at the rear surface of the transfer belt 31.

Furthermore, the transfer unit 25 is provided is provided with a belt cleaning unit 56, which removes toner smearing on the transfer belt 31, and a charge removal unit 55, which executes a charge removal process on the transfer belt 31.

Various charge removal methods are available for the charge removal unit 55, including for example a method in which the transfer belt 31 is grounded via the apparatus, and a method in which an electric field of the opposite polarity to the polarity of the transfer electric field is applied to the transfer belt 31.

The cleaning unit 26 removes and collects toner that is residual on the surface of the photosensitive drum 21 after development and transfer.

The fixing device 27 is provided with a heating roller 35 and a pressure roller 36, and applies heat and pressure to the recording paper to cause the toner image to fix onto the recording paper.

A heat source is arranged inside the heating roller 35 to heat the outer peripheral surface thereof to a predetermined temperature (for example, 160° C. to 200° C.).

The pressure roller 36 is provided with a mechanism such as a load spring at its axial direction end portions and due to this mechanism, a configuration is achieved in which the pressure roller 36 presses against the heating roller 35 with a predetermined load. Furthermore, a paper separation claw and a roller surface cleaning member are arranged on an outer periphery of the pressure roller 36.

In the fixing device 27, the unfixed toner image on the recording paper is subjected to thermal melting and pressure by a fixing process portion, which is the pressing portion between the heating roller 35 and the pressure roller 36, thereby fixing the toner image onto the recording paper.

The recording paper transport portion 104 is provided with transport paths 43 for transporting the recording papers, registration rollers 42, and discharge rollers 46.

In the transport paths 43, the recording paper is taken in from the paper feeding portion 105, then the recording paper is transported until the leading edge of the recording paper reaches the registration rollers 42.

The registration rollers 42 transport the recording paper to the transfer unit 25.

The discharge rollers 46 transport to the discharge tray 47 the recording paper on which a toner image has been fixed by the fixing device 27.

The paper feeding portion 105 is provided with a plurality of paper feed trays 51.

The paper feed trays 51 are trays for storing recording paper and are provided in the lower portion of the image forming apparatus 100. Furthermore, the paper feed trays 51 are provided with a pickup roller or the like for withdrawing the recording paper sheet by sheet, and recording paper that has been withdrawn is fed to the transport paths 43 of the recording paper transport portion 104. It should be noted that the image forming apparatus 100 according to the present embodiment is provided with multiple paper feed trays 51 capable of accommodating from 500 to 1,500 sheets of standard size papers to enable high-speed print processing.

Furthermore, a manual feeding tray 53 is provided at a lateral surface of the image forming apparatus 100 primarily for supplying nonstandard size recording papers, and moreover a large capacity cassette (LCC) 52 capable of accommodating large volumes of multiple types of recording papers may also be provided.

The discharge tray 47 is arranged at a lateral surface of an opposite side to the manual feeding tray 53. Instead of the discharge tray 47, configurations in which post processing devices of the recording paper (stapling, punching and the like) or a plurality of levels of discharge trays are arranged as options are also possible.

### Embodiment 2

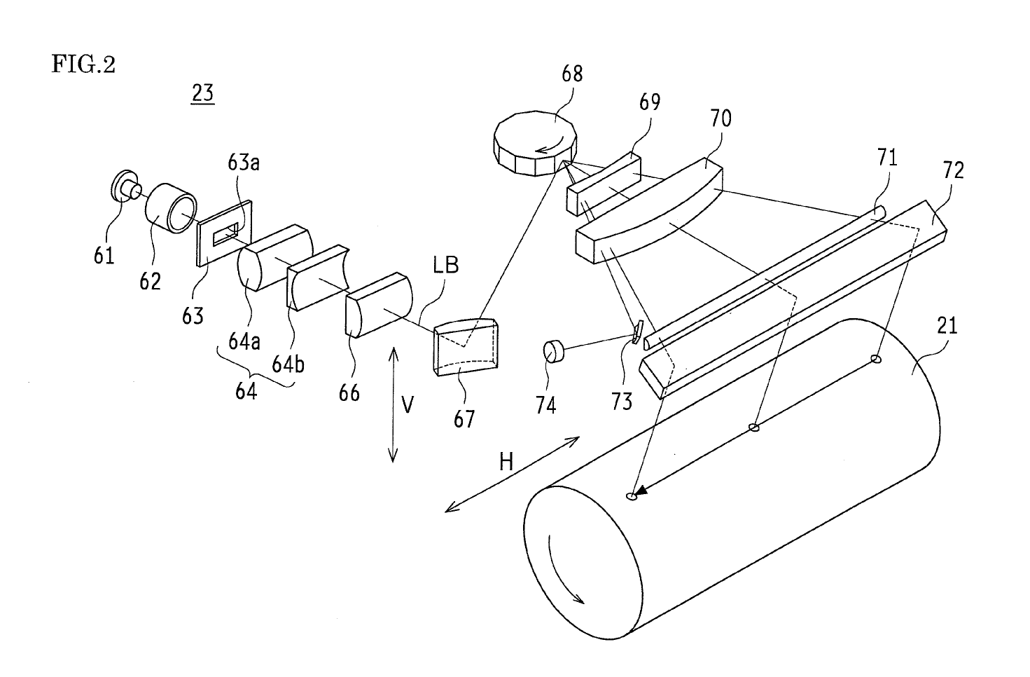

FIG. 2 is an outline perspective view showing a configuration of an optical scanning device according to embodiment 2 of the present invention.

In the optical scanning device 23 according to this embodiment of the present invention, a beam LB outputted from a light source 61 is deflected by an optical deflector 68, and an object to be scanned (the photosensitive drum 21) is scanned by the deflected beam LB. The optical scanning device 23 is provided with a light source 61 that outputs the beam LB, an aperture 63 provided with an opening 63a that shapes the beam LB outputted from the light source 61, and a reducing optical portion 64 that reduces the beam LB shaped by the aperture 63. The aperture 63 and the reducing optical portion 64 are arranged within an interval from the light source 61 to the optical deflector 68.

With this configuration, a beam diameter of an optimal size can be obtained by the reducing optical portion 64. That is, since there is no need to reduce the beam LB with the aperture 63, the size of the opening 63a of the aperture 63 can be enlarged to enable a reduction in the attenuation of the light amount of the beam LB.

In the optical scanning device 23, the light source 61, a collimator 62, the aperture 63, the reducing optical portion 64, a first cylindrical lens 66, a mirror 67, the optical deflector 68, scanning lenses 69 and 70, a second cylindrical lens 71, and a turning mirror 72 are arranged in order from upstream to downstream along an advancement direction of the beam LB.

The beam LB outputted from the optical scanning device 23 is irradiated onto the surface of the photosensitive drum 21. It should be noted that hereinafter the direction in which the beam LB irradiated onto the surface of the photosensitive drum 21 scans is referred to as a first scanning direction H, and the direction orthogonal to the optical axis of the beam LB and orthogonal to the first scanning direction H is referred to as a second scanning direction V.

The optical scanning device 23 is provided with the collimator 62, which is arranged within an interval from the light source 61 to the reducing optical portion 64, and makes the beam LB parallel. With this configuration, a simple configuration can be achieved for outputting the beam LB as a parallel beam. It should be noted that the collimator 62 is arranged on the upstream side from the aperture 63.

The light source 61 is a laser diode for example. A cross section (beam cross section) that is vertical to the optical axis of the beam LB outputted from the light source 61 is a circular shape.

The collimator 62 is an optical component that shapes the conical beam LB, which is outputted from the light source 61 in a diffused manner, into the parallel beam LB.

The aperture 63 is a plate member in which the rectangular opening 63a is centrally formed, and is an optical component that, when the beam LB passes there-through, shapes the beam cross section from an elliptical shape to a rectangular shape.

The reducing optical portion 64 is configured provided with a convex lens 64a and a concave lens 64b, and outputs the incoming beam LB as a parallel beam. With this configuration, a simple configuration can be achieved for outputting the beam LB as a parallel beam, and greater space-saving is possible. Furthermore, by outputting a beam that has been made a parallel beam, the position of the focal point can be adjusted easily, and there is an increased level of freedom in design.

In the present embodiment, the convex lens 64a is configured as a component that converges the beam LB only in the second scanning direction V. The concave lens 64b is a component that makes parallel the beam LB that has been converged in the second scanning direction V by the convex lens 64a. For example, the reduction scaling factor of the reducing optical portion 64 is one times (same scale) with respect to the first scanning direction H and ⅕ times with respect to the second scanning direction V.

As described above, the reduction scaling factor of the reducing optical portion 64 may be configured differently for the first scanning direction H and the second scanning direction V. With this configuration, a suitable reduction scaling factor can be set in response to the shape of the cross section of the beam LB irradiated on the object to be scanned (the photosensitive drum 21).

The size of the opening 63a is determined according to the reduction scaling factor of the reducing optical portion 64. With this configuration, the opening 63a of the aperture 63 can be set to a size for obtaining a beam diameter of an optimal size. Furthermore, the processing for forming the opening 63a becomes easier by increasing the size of the opening 63a of the aperture 63. It should be noted that the size of the opening 63a refers to a width of the opening with respect to the first scanning direction H or the second scanning direction V, and the beam diameter refers to a width of the beam LB with respect to the first scanning direction H or the second scanning direction V.

Furthermore, it is preferable that the size of the opening 63a is smaller in the first scanning direction H and the second scanning direction V than the diameter of the beam that is incident on the aperture 63. With this configuration, the shape of the beam cross section can be shaped reliably by the aperture 63.

The first cylindrical lens 66 and the mirror 67 are optical components for converging the beam LB onto the reflective surfaces of the optical deflector 68.

The optical deflector 68 is a polygon mirror on which multiple reflective surfaces are formed, and is rotationally driven by an unshown driver. The optical deflector 68 is rotationally driven so that the reflected beam LB scans along the first scanning direction H. Hereinafter, the range in which the beam LB scans in the first scanning direction H is referred to as a scanning range. Furthermore, the first scanning direction H is a direction parallel to the rotational axis of the photosensitive drum 21.

As described above, the optical scanning device 23 is provided with the optical deflector 68, which deflects the beam LB outputted from the light source 61 to scan the object to be scanned (the photosensitive drum 21) in the first scanning direction H. With this configuration, the optical scanning device 23 can be achieved that scans the beam LB onto the object to be scanned (the photosensitive drum 21) to form an electrostatic latent image.

The scanning lenses 69 and 70 are optical components for correcting the image distortion that is produced due to the disparity between the optical path length of the beam LB irradiated at the end portions of the scanning range and the optical path length of the beam LB irradiated at the center of the scanning range That is, the scanning lenses 69 and 70 are optical components that cause the beam LB scanned by the optical deflector 68 to scan on the photosensitive drum 21 with a constant velocity, and are also referred to as f-theta lenses.

The second cylindrical lens 71 is an optical component for correcting an optical face tangle error of the optical deflector 68 through a reciprocal action with the first cylindrical lens 66.

The turning mirror 72 is a light reflecting member that reflects the irradiated beam LB and guides it to the surface of the photosensitive drum 21.

Furthermore, the optical scanning device 23 is further provided with a reflective mirror 73 and a BD (beam detector) sensor 74.

The reflective mirror 73 reflects the beam LB that is irradiated from the optical deflector 68 to an end portion of the scanning range and guides it to the BD sensor 74.

The BD sensor 74 receives the beam LB to detect timings of a scanning commencement and scanning completion for each line on the photosensitive drum 21, and outputs the results thereof as a signal.

In the present embodiment, the convex lens 64a is configured as a component that converges the beam LB only in the second scanning direction V, but it is also possible for the convex lens 64a to converge the beam LB in the first scanning direction H and the second scanning direction V.

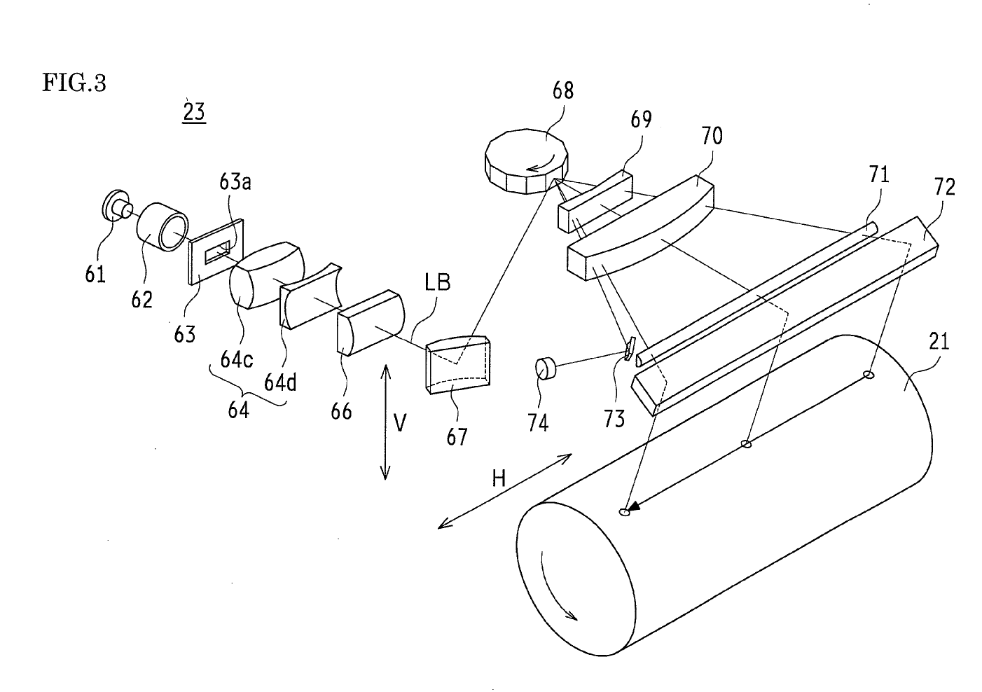

FIG. 3 is an outline perspective view showing a configuration of a modified example of an optical scanning device according to embodiment 1 of the present invention. It should be noted that same reference symbols are assigned to constituent elements whose function and structure are essentially the same as in FIG. 2 and description thereof is omitted.

In the modified example, a convex lens 64c is configured as a component that converges the beam LB in the first scanning direction H and the second scanning direction V. Furthermore, a concave lens 64d is a component that makes parallel the beam LB that has been converged in the first scanning direction H and the second scanning direction V by the convex lens 64c. It should be noted that the reduction scaling factor of the reducing optical portion 64 may be configured differently for the first scanning direction H and the second scanning direction V. With this configuration, a suitable reduction scaling factor can be set in response to the shape of the cross section of the beam irradiated on the object to be scanned.

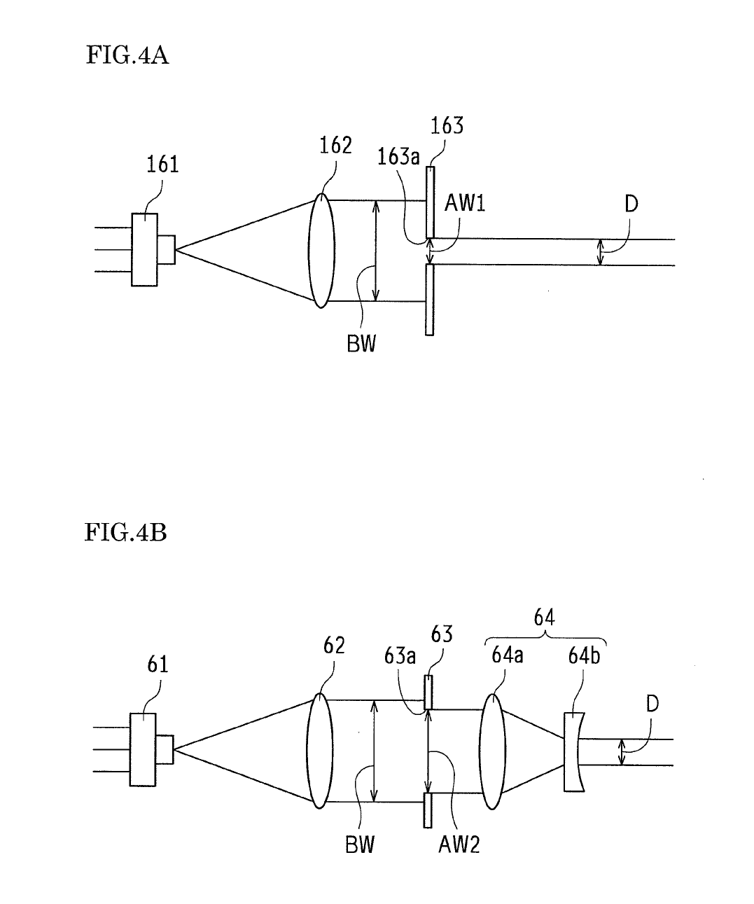

FIG. 4A and FIG. 4B are diagrams for describing a relationship between the beam outputted from the aperture and the reducing optical portion. FIG. 4A is a schematic top view showing the beam in a case where the reducing optical portion is not provided, and FIG. 4B is a schematic top view showing the beam in a case where the reducing optical portion is provided.

In a case where the reducing optical portion is not provided as in FIG. 4A, an opening 163a of an aperture 163 has a narrow opening width AW1. The beam LB outputted from a light source 161 becomes a parallel beam having an irradiated beam width BW due to a collimator 162. In passing through the aperture 163, the beam LB becomes a parallel beam of a beam width D equivalent to the opening width AW1. Here, due to the beam LB being blocked by the aperture 163, the light amount of the beam LB attenuates. Along with the difference becoming greater between the irradiated beam width BW and the opening width AW1, the light amount is greatly attenuated.

In a case where the reducing optical portion is provided as in FIG. 4B, the opening 63a of the aperture 63 has an opening width AW2 that is wider than the opening width AW1 of FIG. 4A. That is, by reducing the difference between the opening width AW2 and the irradiated beam width BW, attenuation of the light amount of the beam LB is reduced.

The beam LB outputted from the light source 61 becomes a parallel beam having the irradiated beam width BW due to the collimator 62. In passing through the aperture 63 having the opening width AW2, the beam LB becomes a parallel beam of a beam width equivalent to the opening width AW2. The beam LB that has passed through the aperture 63 becomes a parallel beam having the beam width D due to the reducing optical portion 64.

In the case shown in FIG. 4A, the opening width AW1 is narrow compared to the irradiated beam width BW, and therefore the beam LB is greatly blocked and the light amount is greatly attenuated. In the present embodiment, the opening width AW2 is widened as shown in FIG. 4B so that attenuation of the light amount of the beam LB is reduced. Furthermore, due to the reducing optical portion 64, an optimal beam width D required on the downstream side is achieved.

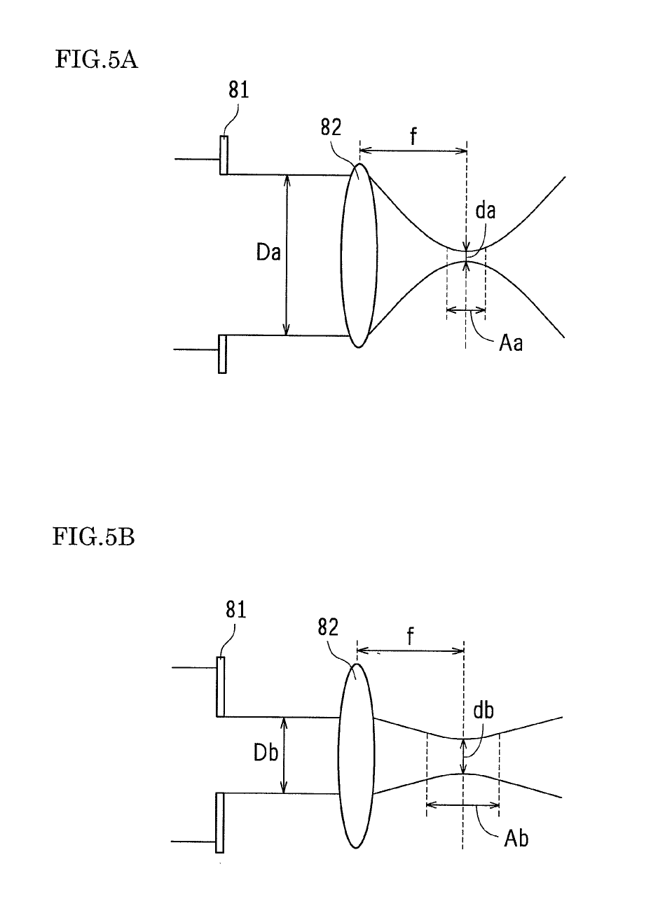

FIG. 5A and FIG. 5B are diagrams for describing a relationship between the beam diameter and the depth of focus. FIG. 5A is a schematic top view showing a case where the beam diameter is large, and FIG. 5B is a schematic top view showing a case where the beam diameter is small.

As described above, the beam LB outputted from the light source 61 is converged onto the reflective surfaces of the optical deflector 68 by the first cylindrical lens 66 and the mirror 67, and the surface of the photosensitive drum 21 is exposed by the converged beam LB. At this time, if the beam LB is not sufficiently converged, the light amount required for exposing the photosensitive drum 21 cannot be obtained.

Generally, the depth of focus varies according to the width of the beam that is incident on the lens. Here, the depth of focus refers to the range on the optical axis where a certain level of resolving power can be maintained. That is, if the image surface (the surface of the photosensitive drum 21) is contained in the depth of focus, then the light amount required for exposure can be secured. The relationship between the beam width and the depth of focus can be expressed by the following equations.

d=2.44×(λ×f)/D

A=2×(λ×f²)/D²

Here, λ is the beam wavelength, f is the focal point distance (the distance from the lens to the focal point), D is the incoming beam width, d is the spot diameter (beam width at the focal point), and A is the depth of focus.

From the above equations, it is evident that along with the incoming beam width D becoming smaller, the spot diameter d and the depth of focus A become larger.

In FIG. 5A, the beam LB having a large incoming beam width Da due to an aperture 81 is converged on a lens 82. When the incoming beam width Da is large, a spot diameter da can be narrowed down and made small, but a depth of focus Aa becomes narrow. Furthermore, when the image surface is out of the focal point, the variation in the beam diameter becomes larger.

In FIG. 5B, the beam LB having a small incoming beam width Db due to the aperture 81 is converged on the lens 82. Compared to the case of FIG. 5A, when the incoming beam width Db is small, a spot diameter db becomes larger and a depth of focus Ab becomes wider. Furthermore, even if the image surface is out of the focal point, the variation in the beam diameter is small.

As described above, if the incoming beam width D is made small, the depth of focus A becomes wide, and therefore image surface displacement or the like can be easily addressed. As shown in FIG. 5A, in a case where the beam LB having the incoming beam width Da is converged without being reduced by the reducing optical portion 64, it becomes difficult to address image surface displacement. In the present embodiment, a beam diameter having an optimal size is obtained by reducing the beam LB using the reducing optical portion 64.

### Embodiment 3

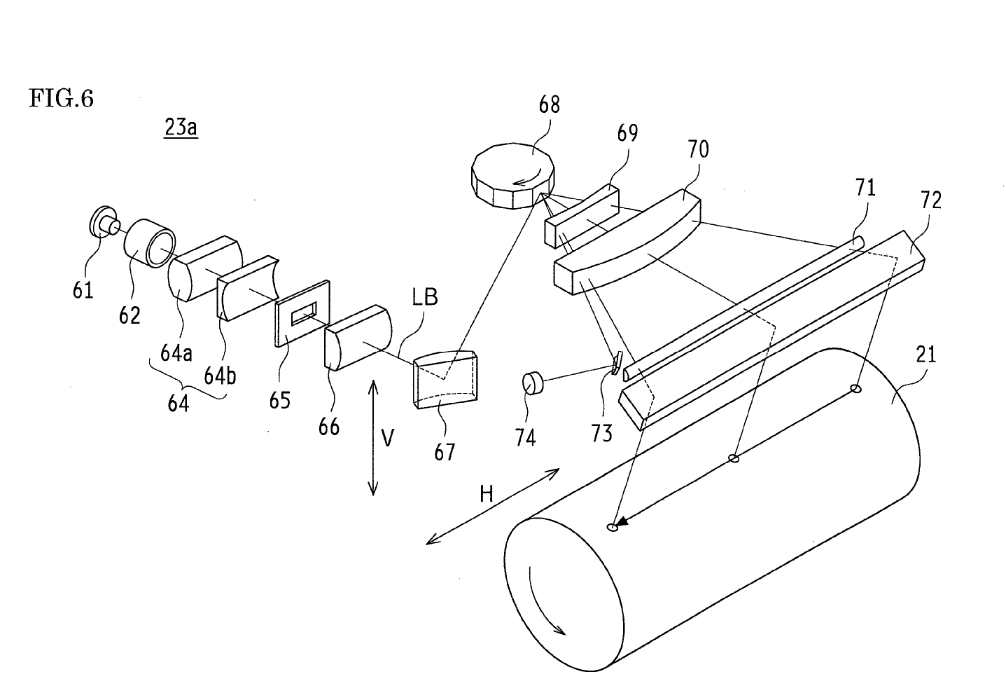

FIG. 6 is an outline perspective view showing a configuration of an optical scanning device according to embodiment 3 of the present invention. It should be noted that same reference symbols are assigned to constituent elements whose function and structure are essentially the same as in embodiment 2 and description thereof is omitted.

In an optical scanning device 23a according to this embodiment of the present invention, the beam LB outputted from the light source 61 is deflected by the optical deflector 68, and an object to be scanned (the photosensitive drum 21) is scanned by the deflected beam LB. The optical scanning device 23a is provided with the light source 61 that outputs the beam LB, the reducing optical portion 64 that reduces the beam LB outputted from the light source 61, and the aperture 65 provided with an opening 65a that shapes the beam LB reduced by the reducing optical portion 64. The reducing optical portion 64 and the aperture 65 are arranged within an interval from the light source 61 to the optical deflector 68.

With this configuration, due to the reducing optical portion 64, the beam diameter can be reduced without the light amount of the beam LB being attenuated. Furthermore, since the beam diameter is reduced, an aperture 65 having a small size can be applied, which is beneficial in making the apparatus more compact.

In the optical scanning device 23a, the light source 61, the collimator 62, the reducing optical portion 64, the aperture 65, the first cylindrical lens 66, the mirror 67, the optical deflector 68, scanning lenses 69 and 70, the second cylindrical lens 71, and the turning mirror 72 are arranged in order from upstream to downstream along the advancement direction of the beam. The beam LB outputted from the optical scanning device 23a is irradiated onto the surface of the photosensitive drum 21. That is, embodiment 3 is different from embodiment 2 in that the reducing optical portion 64 is arranged upstream from the aperture 65.

The reducing optical portion 64 is configured provided with the convex lens 64a and the concave lens 64b, and outputs the incoming beam LB as a parallel beam. With this configuration, a simple configuration can be achieved for outputting the beam LB as a parallel beam, and greater space-saving is possible. Furthermore, by outputting a beam that has been made a parallel beam, the position of the focal point can be adjusted easily, and there is an increased level of freedom in design.

The optical scanning device 23a is provided with the collimator 62, which is arranged within an interval from the light source 61 to the reducing optical portion 64, and makes the beam LB parallel. With this configuration, a simple configuration can be achieved for outputting the beam LB as a parallel beam. It should be noted that the collimator 62 is arranged on the upstream side from the aperture 65.

The present invention can be embodied and practiced in other different forms without departing from the spirit and essential characteristics thereof. Therefore, the above-described working examples are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An optical scanning device in which a beam outputted from a light source is deflected by an optical deflector, and an object to be scanned is scanned by the deflected beam, comprising:
a light source that outputs a beam,
an aperture provided with an opening that shapes the beam, and
a reducing optical portion that reduces the beam,
wherein the aperture and the reducing optical portion are arranged within an interval from the light source to the optical deflector.

2. The optical scanning device according to claim 1,
wherein the aperture shapes the beam outputted from the light source, and
the reducing optical portion reduces the beam shaped by the aperture.

3. The optical scanning device according to claim 2,
wherein a size of the opening is determined according to a reduction scaling factor of the reducing optical portion.

4. The optical scanning device according to claim 1,
wherein the reducing optical portion reduces the beam outputted from the light source, and
the aperture shapes the beam reduced by the reducing optical portion.

5. The optical scanning device according to claim 2,
wherein the reducing optical portion is configured provided with a convex lens and a concave lens, and outputs the incoming beam as a parallel beam.

6. The optical scanning device according to claim 4,
wherein the reducing optical portion is configured provided with a convex lens and a concave lens, and outputs the incoming beam as a parallel beam.

7. The optical scanning device according to claim 5,
wherein the concave lens is arranged between the convex lens and the optical deflector.

8. The optical scanning device according to claim 6,
wherein the concave lens is arranged between the convex lens and the optical deflector.

9. The optical scanning device according to claim 7,
further comprising a cylindrical lens that is arranged between the concave lens and the optical deflector.

10. The optical scanning device according to claim 8,
further comprising a cylindrical lens that is arranged between the concave lens and the optical deflector.

11. The optical scanning device according to claim 5,
comprising a collimator, which is arranged within an interval from the light source to the reducing optical portion, and makes the beam parallel.

12. The optical scanning device according to claim 6,
comprising a collimator, which is arranged within an interval from the light source to the reducing optical portion, and makes the beam parallel.

13. The optical scanning device according to claim 5,
wherein a reduction scaling factor of the reducing optical portion is different for a first scanning direction in which a beam scans an object to be scanned and a second scanning direction that is orthogonal to the first scanning direction.

14. The optical scanning device according to claim 6,
wherein a reduction scaling factor of the reducing optical portion is different for a first scanning direction in which a beam scans an object to be scanned and a second scanning direction that is orthogonal to the first scanning direction.

15. The optical scanning device according to claim 13,
wherein a reduction scaling factor of the reducing optical portion is one times the reduction scaling factor of the first scanning direction.

16. The optical scanning device according to claim 14,
wherein a reduction scaling factor of the reducing optical portion is one times the reduction scaling factor of the first scanning direction.

17. An image forming apparatus that comprises an optical scanning device in which a beam outputted from a light source is deflected by an optical deflector, and an object to be scanned is scanned by the deflected beam,
and that is configured to form an image based on light scanned by the optical scanning device,
wherein the optical scanning device is provided with:
a light source that outputs a beam,
an aperture provided with an opening that shapes the beam, and
a reducing optical portion that reduces the beam,
wherein the aperture and the reducing optical portion are arranged within an interval from the light source to the optical deflector.

18. The image forming apparatus according to claim 17,
wherein the aperture shapes the beam outputted from the light source, and
the reducing optical portion reduces the beam shaped by the aperture.

19. The image forming apparatus according to claim 17,
wherein the reducing optical portion reduces the beam outputted from the light source, and
the aperture shapes the beam reduced by the reducing optical portion.
